(19) United States
(12) Patent Application Publication
(10) Pub. No.: US 2018/0081375 A1
(43) Pub. Date: Mar. 22, 2018

(54) Systems, Devices, and Methods for Providing Drone Assistance

(71) Applicant: Wal-Mart Stores, Inc., Bentonville, AR (US)

(72) Inventors: Robert James Taylor, Rogers, AR (US); Matthew Allen Jones, Bentonville, AR (US); Aaron Vasgaard, Fayetteville, AR (US); Nicholaus Adam Jones, Fayetteville, AR (US)

(21) Appl. No.: 15/708,405

(22) Filed: Sep. 19, 2017

Related U.S. Application Data
(60) Provisional application No. 62/397,058, filed on Sep. 20, 2016.

(51) Int. Cl. G05D 1/10; G08G 5/04; G05D 1/00; B64C 39/02; G06Q 30/02

(52) U.S. Cl. CPC G05D 1/101; G08G 5/045; G05D 1/0027; B64C 2201/146; G05D 1/0038; B64C 39/024; G06Q 30/0283; G05D 1/005

(57) ABSTRACT

A technique for providing drone assistance is discussed. A computing device is in wireless communication with a mobile electronic device and an aerial drone. The computing device can control the aerial drone to travel to the location of a user of the mobile electronic device in response to a request for assistance received via the user's mobile electronic device. Once the aerial drone has arrived at the location of the user, the computing device can also control the aerial drone to provide price verification of a user-specified object or to provide navigation assistance via the aerial drone to guide the user to the user-specified object.

### CROSS-REFERENCE TO RELATED PATENT APPLICATIONS

This application claims priority to U.S. Provisional Application No. 62/397,058 filed on Sep. 20, 2016, the content of which is hereby incorporated by reference in its entirety.

### BACKGROUND OF THE TECHNOLOGY

Drone technology has rapidly developed in recent years. Aerial drones may be equipped with a variety of sensors with which to acquire data. Further, the drones may be configured with a variety of communication capabilities that allow them to interact with computing devices on the ground.

### SUMMARY

Embodiments of the present invention utilize a computing device in communication with an aerial drone and a user's mobile electronic device to provide navigation assistance or price verification to the user. For example, embodiments may include a user's mobile electronic device, an aerial drone, and a computing device in communication with the mobile electronic device and the aerial drone. In some embodiments, a user of the mobile electronic device can summon the aerial drone by submitting a request for assistance via the user's mobile electronic device, and the computing device can control the aerial drone to travel to the location of the user and the mobile electronic device. Once summoned, the aerial drone can provide assistance to the user in the form of price verification or navigation assistance.

In one embodiment, a system for providing drone assistance includes an aerial drone, a mobile electronic device operated by a user, and a computing device equipped with a processor and in communication with the aerial drone and the mobile electronic device. The computing device is configured to execute a drone summoning module that receives a request for assistance from the user's mobile electronic device and, in response to the request, instructs the aerial drone to travel to a location of the user operating the mobile electronic device. The computing device is also configured to execute a drone assistance module that controls the aerial drone to provide a price verification of a user-specified object or to provide navigation assistance via the aerial drone to the user to enable the user to navigate to the user-specified object.

In another embodiment, a method for providing aerial drone assistance includes receiving a request for assistance at a computing device from a mobile electronic device operated by a user. The computing device is in communication with an aerial drone and the mobile electronic device. The method also includes controlling the aerial drone, using a drone summoning module so that the drone travels to a location of the user operating the mobile electronic device. the method also includes controlling the aerial drone, using a drone assistance module so that the drone provides a price verification of a user-specified object or so that the drone provides navigation assistance via the aerial drone to the user to enable the user to navigate to the user-specified object.

Additional combinations and/or permutations of the above examples are envisioned as being within the scope of the present disclosure. It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

The foregoing and other features and advantages provided by the present disclosure will be more fully understood from the following description of exemplary embodiments of the present invention when read together with the accompanying drawings, in which:

FIG. 1 is a flowchart illustrating an exemplary method of providing aerial drone assistance, in accordance with an exemplary embodiment.

FIG. 2 is a flowchart illustrating another exemplary method of providing aerial drone assistance, in accordance with an exemplary embodiment.

FIG. 3 is a diagram of an exemplary network environment suitable for a distributed implementation of an exemplary embodiment.

FIG. 4 is a block diagram of an exemplary computing device that can be used to perform exemplary processes in accordance with an exemplary embodiment.

### DETAILED DESCRIPTION

Following below are more detailed descriptions of various concepts related to, and embodiments of, inventive methods, apparatus, and systems for providing aerial drone assistance. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

As used herein, the term “includes” means “includes but is not limited to”, the term “including” means “including but not limited to”. The term “based on” means “based at least in part on”.

In accordance with some embodiments of the present invention, methodologies, systems, devices, and non-transitory computer-readable media are described herein to provide aerial drone assistance. In exemplary embodiments, a computing device is in communication with one or more aerial drones and a mobile electronic device that can be operated by a user. The aerial drones can be, for example, unmanned multirotor helicopters, and they can be controlled by the computing device to perform a number of tasks. In some embodiments, the computing device can control an aerial drone to travel to the location of a user of a mobile electronic device in response to a request for assistance from the user. The user can request price verification and/or navigation assistance, for example, through a user interface of the mobile electronic device. In some embodiments, the mobile electronic device can be a personal device or a mobile electronic device provided to the user temporarily in order to assist in completing one or more tasks.

Once the aerial drone travels to the location of the user who requested assistance, the aerial drone can provide price verification or navigation assistance to the user. If, for example, the user has requested navigation assistance to an item selected from a virtual shopping list on the mobile electronic device, the computing device can control the aerial drone to provide navigation assistance to guide the user to the location of the selected item. In some embodiments, the navigation assistance can be in the form of a visual projection to indicate a path the user needs to take in order to reach an item or an audio output from the aerial drone which the user can follow to reach the item. If the user has requested price verification, the computing device can control the aerial drone to provide price verification in the form of a visual projection, a visual display or an audio output of the price. In some embodiments, the aerial drone can be configured to scan a barcode or other machine-readable code associated with the user-selected item to first obtain the price in order to provide price verification. For example, the computing device may instruct the drone to travel to the item whose location is stored in a database in order to acquire the most up to date price in case the prices stored in the database do not reflect the most recent price alteration. In other embodiments the price may be listed in a database to which the computing device has access and the computing device may provide the price to the aerial drone to convey to the user.

In some embodiments, once the aerial drone has finished providing assistance to the user, the computing device can control the aerial drone to return to a specified docking station or charging station until it is summoned again. In some cases, the docking station or charging station can be centrally located and can include multiple stations for numerous drones. In some embodiments, different types of aerial drones equipped with different features, such as display screens, speakers, visual projectors, etc. can be deployed to perform different types of tasks associated with providing assistance to a user.

In some embodiments, the computing device can control the aerial drones in order to prevent collisions between the drones or other obstacles. The aerial drones can be equipped with location sensors, proximity sensors, or other collision avoidance sensors. The computing device can communicate with the various sensors of the aerial drones in order to determine the location of each aerial drone and prevent collisions with other drones, walls, shelves, or other stationary or mobile obstacles.

Exemplary embodiments are described below with reference to the drawings. One of ordinary skill in the art will recognize that exemplary embodiments are not limited to the illustrative embodiments, and that components of exemplary systems, devices and methods are not limited to the illustrative embodiments described below.

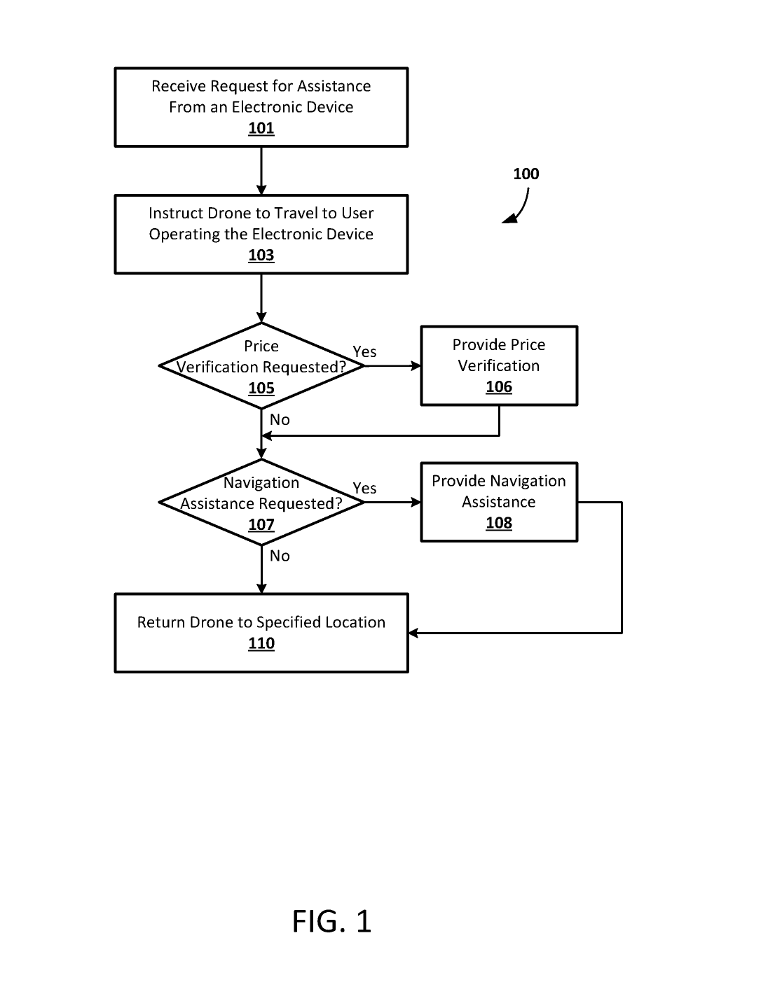

FIG. 1 is a flowchart illustrating an exemplary method 100 for providing drone assistance, in accordance with an exemplary embodiment. It will be appreciated that the method is programmatically performed by one or more computer-executable processes executing on, or in communication with, one or more servers described further below. In step 101, a processor of a computing device receives a request for assistance from a mobile electronic device operated by a user. In some embodiments, a drone summoning module is executed by the processor and receives the request for assistance. The computing device is in communication with an aerial drone and the mobile electronic device operated by the user. As discussed above, the mobile electronic device can include, for example, a personal device or a mobile electronic device provided to the user temporarily in order to assist in completing one or more tasks. In some embodiments, a request for price verification assistance can include scanning a barcode or other machine readable code associated with an object using a camera or scanner of the mobile electronic device. In other embodiments, a request for assistance can include selecting an item on a virtual shopping list displayed via the mobile electronic device.

In step 103, the drone summoning module controls the aerial drone in response to the request for assistance and instructs the aerial drone to travel to the location of the user operating the mobile electronic device. The mobile electronic device can communicate with the computing device, in some embodiments, in order to provide location information to guide the aerial drone to the proper location. For example, the mobile device may provide GPS coordinates of the mobile electronic device's current location to the computing device and the computing device may instruct the aerial drone to travel to the coordinates. The aerial drone can be initially located at a docking and/or charging station from which the drone can be deployed.

In step 105, the method determines whether the assistance requested involves price verification. If price verification assistance is requested, the method continues to step 106 in which the processor executes a drone assistance module that controls the aerial drone to provide price verification of a user-specified object. To initially provide the price to the aerial drone, the computing device may retrieve the price from a database and provide it to the aerial drone. Alternatively, the computing device may retrieve a location of the item in question from a database and instruct the drone to provide to the item's location to acquire the price. In some embodiments, the aerial drone can be equipped with a camera, an RFID reader and/or a scanning device. For example, the aerial drone may scan a machine-readable code of the item such as a barcode or QR code, may read an RFID tag which has price information or may visually read a price using video analytics. After obtaining the price, the aerial drone conveys the price to the user of the mobile electronic device that originated the request. In some embodiments, the price verification can be provided to the user by a visual projection or audio output from the aerial drone. For example, the aerial drone can play an audio message telling the price of the user-specified object, or the aerial drone can project an image of the price of the user-specified object. In another embodiment, the aerial drone may be equipped with a display and may display the price to the user by hovering in the user's vicinity.

After price verification has been provided in step 106, or after it is determined in step 105 that no price verification has been requested, the method continues to step 107 in which the method determines whether the assistance requested involves navigation assistance. If navigation assistance is requested, the method continues to step 108 in which the processor executes the drone assistance module to control the aerial drone to provide navigation assistance to enable the user to navigate to the user-specified object. In some embodiments, the aerial drone provides navigation assistance by receiving the location of the item from the computing device and using a visual projection, such as an image projected onto the floor ahead of the user, that can guide the user to the location of the user-specified object. In other embodiments, the aerial drone can hover or fly near the user and provide audio directions to guide the user to the location of the user-specified object. The computing device can also communicate with the mobile electronic device, in some embodiments, to provide additional navigation assistance to the user via the mobile electronic device. For example, navigation assistance can be provided using a mapping software of the mobile electronic device operated by the user.

After navigation assistance has been provided in step 108, or after it is determined in step 107 that navigation assistance has not been requested, the method continues with step 110 in which the processor of the computing device executes a drone return module that commands the aerial drone to return to a specified location after executing the drone assistance module. In some embodiments, the specified location can be a docking or charging station where the drone can remain until another request for assistance is received at the computing device. The docking station can allow the computing device to communicate with the aerial drone while the drone is not actively assisting users.

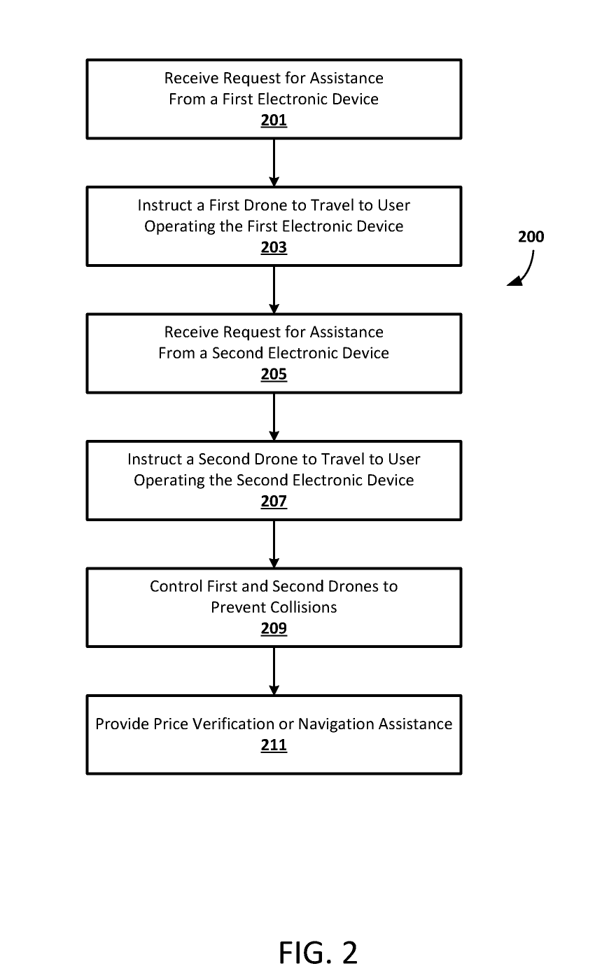

FIG. 2 is a flowchart illustrating another exemplary method 200 for providing drone assistance, in accordance with an exemplary embodiment. It will be appreciated that the method is programmatically performed by one or more computer-executable processes executing on, or in communication with, one or more servers described further below. In step 201, a computing device receives a request for assistance from a first mobile electronic device operated by a user. The computing device is in communication with the first mobile electronic device, as well as two or more aerial drones. The mobile electronic device can include, for example, a personal mobile electronic device operated by a user or a mobile electronic device provided to the user temporarily in order to assist in completing one or more tasks. In some embodiments, the request for assistance can include a request for price verification or a request for navigation assistance, as discussed above.

Once the request for assistance is received, the processor of the computing device executes a drone summoning module in step 203 and controls a first aerial drone to travel to the location of the user operating the first mobile electronic device. In some embodiments, the aerial drones can be located at a docking station or charging station from which one or more of the drones can be deployed.

In step 205, the computing device receives a request for assistance from a second mobile electronic device operated by a second user. The computing device is also in communication with the second mobile electronic device, and the request for assistance from the second mobile electronic device can also include a request for price verification or a request for navigation assistance.

Once the request for assistance is received from the second mobile electronic device, the processor of the computing device executes the drone summoning module in step 207 and controls a second aerial drone to travel to the location of the user operating the second mobile electronic device. As discussed above, the aerial drones can be located at a docking station or charging station from which one or more of the aerial drones can be deployed. In other embodiments, the aerial drones may be located at a number of docking or charging stations distributed throughout an enterprise. It will be appreciated that the aerial drones that are deployed to the first and second mobile electronic device may also be already airborne. In some cases, the choice of which aerial drone to deploy to the first mobile electronic device in step 203 and which aerial drone to deploy to the second mobile electronic device in step 207 is made based on which aerial drone is closest to each of the mobile electronic devices.

In step 209, the processor of the computing device executes a drone control module to control the first aerial drone and the second aerial drone to prevent collisions between the aerial drones. The aerial drones can also include various location sensors and/or proximity sensors in order to prevent collisions between the aerial drones. In some embodiments, the drone control module can also control the aerial drones to prevent collisions between walls, shelves, or other obstacles that the drone may need to maneuver around.

In step 211, the first aerial drone provides price verification or navigation assistance to the user of the first mobile electronic device, and the second aerial drone provides price verification or navigation assistance to the user of the second mobile electronic device. As discussed above, the price verification and/or navigation assistance can be provided by the aerial drones in the form of a visual projection, visual display or an audio output, in some embodiments. For example, the drones can project an image of the price of the user-specified object or output an audio message announcing the price of the object. If so equipped, the drones may display the price to the user on an integrated display. In some embodiments, the navigation instructions can guide the users to the user-specified objects using an image projected onto the floor or by providing audio directions to guide the users to their respective objects.

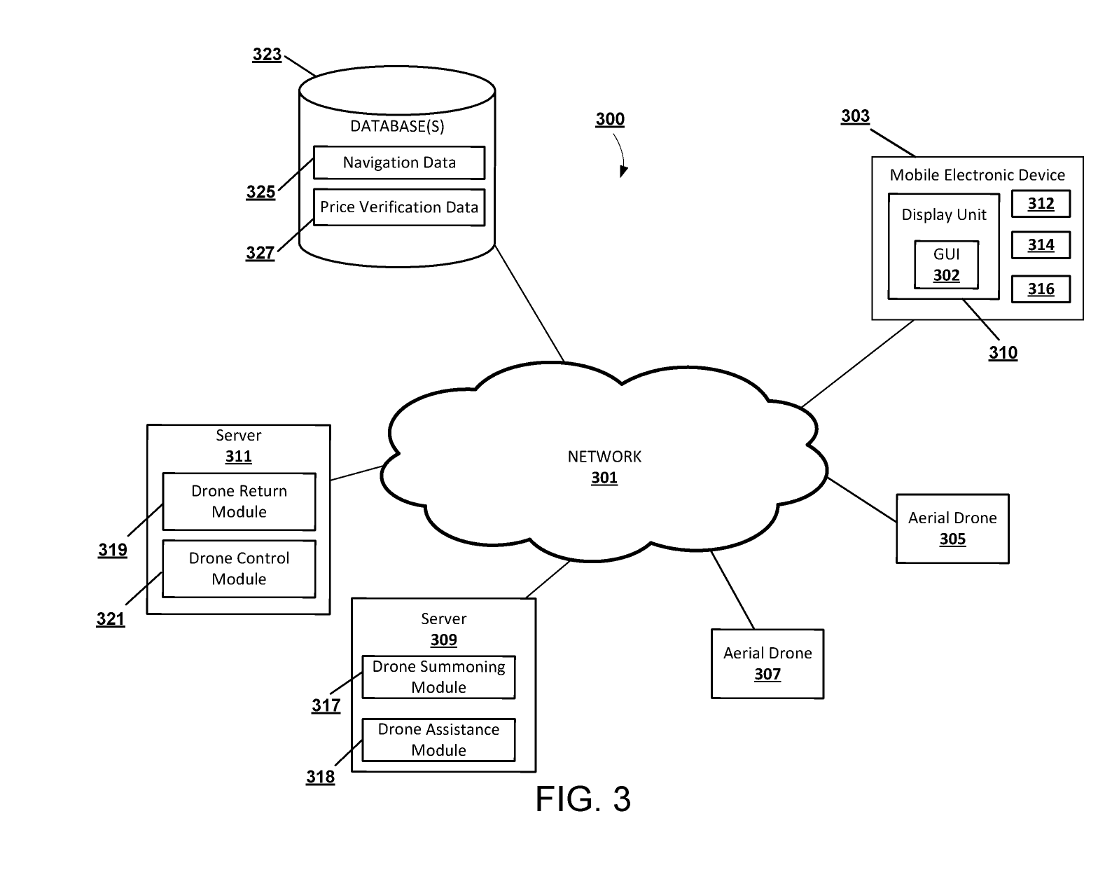

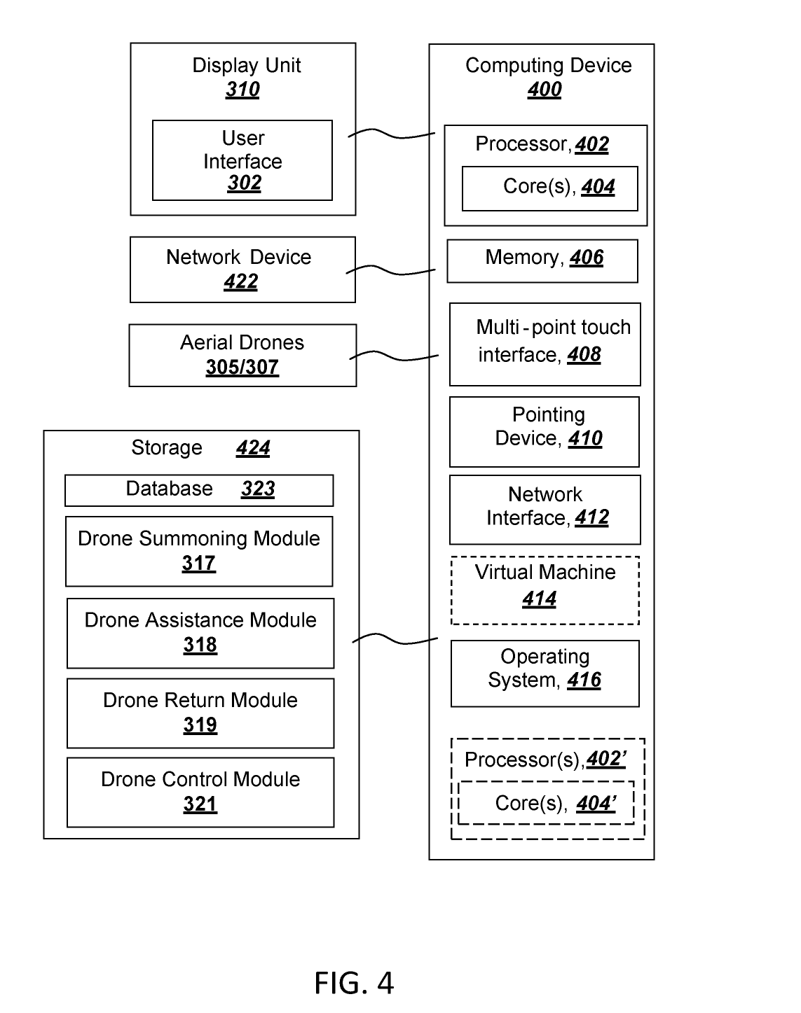

FIG. 3 illustrates a network diagram depicting a system 300 suitable for a distributed implementation of exemplary embodiments. The system 300 can include a network 301, mobile electronic device 303, aerial drones 305 and 307, servers 309 and 311, and a database 323. As will be appreciated, various distributed or centralized configurations may be implemented. In exemplary embodiments, server 309 can store a drone summoning module 317 and a drone assistance module 318, while server 311 can store a drone return module 319 and a drone control module 321, each of which can implement one or more of the processes described herein with reference to FIGS. 1-2, or portions thereof. It will be appreciated that the module functionality may be implemented as a greater or lesser number of modules than illustrated, and that the same server could also host multiple modules. The database 323 can store various navigation data 325 and price verification data 327, in exemplary embodiments. In some embodiments, one or more of the servers 309 and 311 can be included in a computing device that may include some or all of the components described in relation to computing device 400 shown in FIG. 4.

In exemplary embodiments, the mobile electronic device 303 may include a display unit 310, which can display a graphical user interface (GUI) 302 to a user of the mobile electronic device. The GUI 302 can allow the user to initiate a request for navigation assistance or a price verification request, as described herein. The mobile electronic device 303 can also include a memory 312, processor 314, and a wireless interface 316. In some embodiments, the mobile electronic device 303 may include, but is not limited to, computers, general purpose computers, Internet appliances, hand-held devices, wireless devices, portable devices, wearable computers, cellular or mobile phones, portable digital assistants (PDAs), smart phones, tablets, ultrabooks, netbooks, laptops, multi-processor systems, microprocessor-based or programmable consumer electronics, mini-computers, smartphones, tablets, netbooks, and the like equipped with, or in communication with, a display surface.

The mobile electronic device 303 may connect to network 301 via a wired or wireless connection. The mobile electronic device 303 may include one or more applications such as, but not limited to, a web browser, a sales transaction application, an object reader application, and the like.

In exemplary embodiments, the mobile electronic device 303, aerial drones 305 and 307, servers 309 and 311, and database 323 may be in communication with each other via the communication network 301. The communication network 301 may include, but is not limited to, the Internet, an intranet, a LAN (Local Area Network), a WAN (Wide Area Network), a MAN (Metropolitan Area Network), a wireless network, an optical network, and the like. In one embodiment, the mobile electronic device 303, aerial drones 305 and 307, and servers 309 and 311 can transmit instructions to each other over the communication network 301. In exemplary embodiments, the navigation data 325 which may involve item location, and price verification data 327 can be stored at database 323 and received at the servers 309 and 311 or the aerial drones 305 and 307 in response to a service performed by a database retrieval application.

FIG. 4 is a block diagram of an exemplary computing device 400 that can be used in the performance of any of the example methods according to the principles described herein. The computing device 400 includes one or more non-transitory computer-readable media for storing one or more computer-executable instructions (such as but not limited to software or firmware) for implementing any example method according to the principles described herein. The non-transitory computer-readable media can include, but are not limited to, one or more types of hardware memory, non-transitory tangible media (for example, one or more magnetic storage disks, one or more optical disks, one or more USB flashdrives), and the like.

For example, memory 406 included in the computing device 400 can store computer-readable and computer-executable instructions or software for implementing exemplary embodiments and programmed to perform processes described above in reference to FIGS. 1-2. The computing device 400 also includes processor 402 and associated core 404, and optionally, one or more additional processor(s) 402′ and associated core(s) 404′ (for example, in the case of computer systems having multiple processors/cores), for executing computer-readable and computer-executable instructions or software stored in the memory 406 and other programs for controlling system hardware. Processor 402 and processor(s) 402′ can each be a single core processor or multiple core (404 and 404′) processor.

Virtualization can be employed in the computing device 400 so that infrastructure and resources in the computing device can be shared dynamically. A virtual machine 414 can be provided to handle a process running on multiple processors so that the process appears to be using only one computing resource rather than multiple computing resources. Multiple virtual machines can also be used with one processor.

Memory 406 can be non-transitory computer-readable media including a computer system memory or random access memory, such as DRAM, SRAM, EDO RAM, and the like. Memory 406 can include other types of memory as well, or combinations thereof.

A user can interact with the computing device 400 through a display unit 310, such as a touch screen display or computer monitor, which can display a GUI 302 that can be provided in accordance with exemplary embodiments. The computing device 400 can also include other I/O devices for receiving input from a user, for example, a keyboard or any suitable multi-point touch interface 408, a pointing device 410 (e.g., a pen, stylus, mouse, or trackpad). The multi-point touch interface 408 and the pointing device 410 can be coupled to the display unit 310. The computing device 400 can include other suitable conventional I/O peripherals.

The computing device 400 can also include one or more storage devices 424, such as a hard-drive, CD-ROM, or other non-transitory computer readable media, for storing data and computer-readable instructions and/or software, such as drone summoning module 317, a drone assistance module 318, a drone return module 319, and a drone control module 321 that can implement exemplary embodiments of the methods and systems as taught herein, or portions thereof. Exemplary storage device 424 can also store one or more databases 323 for storing any suitable information required to implement exemplary embodiments. The databases can be updated by a user or automatically at any suitable time to add, delete, or update one or more items in the databases. Exemplary storage device 424 can store one or more databases 323 for storing the navigation data 325, price verification data 327, and any other data/information used to implement exemplary embodiments of the systems and methods described herein. The computing device 400 can also be in communication with one or more aerial drones 305 and 307 that can identify an activity status of each of a plurality of terminals, as discussed above.

The computing device 400 can include a network interface 412 configured to interface via one or more network devices 422 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 412 can include a built-in network adapter, network interface card, PCMCIA network card, card bus network adapter, wireless network adapter, USB network adapter, modem or any other device suitable for interfacing the computing device 400 to any type of network capable of communication and performing the operations described herein.

Moreover, the computing device 400 can be any computer system, such as a workstation, desktop computer, server, laptop, handheld computer, tablet computer (e.g., the iPad® tablet computer), mobile computing or communication device (e.g., the iPhone® communication device), or other form of computing or telecommunications device that is capable of communication and that has sufficient processor power and memory capacity to perform the operations described herein.

The computing device 400 can run operating system 416, such as versions of the Microsoft® Windows® operating systems, different releases of the Unix and Linux operating systems, versions of the MacOS® for Macintosh computers, embedded operating systems, real-time operating systems, open source operating systems, proprietary operating systems, operating systems for mobile computing devices, or any other operating system capable of running on the computing device and performing the operations described herein. In exemplary embodiments, the operating system 416 can be run in native mode or emulated mode. In an exemplary embodiment, the operating system 416 can be run on one or more cloud machine instances.

In describing example embodiments, specific terminology is used for the sake of clarity. For purposes of description, each specific term is intended to at least include all technical and functional equivalents that operate in a similar manner to accomplish a similar purpose. Additionally, in some instances where a particular example embodiment includes system elements, device components or method steps, those elements, components or steps can be replaced with a single element, component or step. Likewise, a single element, component or step can be replaced with a plurality of elements, components or steps that serve the same purpose. Moreover, while example embodiments have been shown and described with references to particular embodiments thereof, those of ordinary skill in the art will understand that various substitutions and alterations in form and detail can be made therein without departing from the scope of the disclosure. Further still, other aspects, functions and advantages are also within the scope of the disclosure.

Example flowcharts are provided herein for illustrative purposes and are non-limiting examples of methods. One of ordinary skill in the art will recognize that example methods can include more or fewer steps than those illustrated in the example flowcharts, and that the steps in the example flowcharts can be performed in a different order than the order shown in the illustrative flowcharts.

What is claimed is:

1. A system for providing drone assistance comprising:
an aerial drone;
a mobile electronic device operated by a user; and
a computing device equipped with a processor and in communication with the aerial drone and the mobile electronic device, wherein the computing device is configured to execute:
a drone summoning module, the drone summoning module configured to receive a request for assistance from the mobile electronic device and, in response to the request, instruct the aerial drone to travel to a location of the user operating the mobile electronic device; and
a drone assistance module, the drone assistance module configured to control the aerial drone to provide a price verification of a user-specified object or to provide navigation assistance via the aerial drone to the user to enable the user to navigate to the user-specified object.

2. The system of claim 1, wherein the mobile electronic device associated with the user includes a personal device operated by the user.

3. The system of claim 1, wherein the navigation assistance includes a visual projection or an audio output from the aerial drone.

4. The system of claim 1, wherein the price verification includes a visual projection or an audio output from the aerial drone.

5. The system of claim 1, wherein the computing device is configured to communicate with the mobile electronic device to provide navigation assistance to the user via the mobile electronic device.

6. The system of claim 1, wherein the computing device is further configured to execute a drone return module, the drone return module configured to command the aerial drone to return to a specified location after executing the drone assistance module.

7. The system of claim 1, wherein the computing device is further configured to execute a drone control module, the drone control module configured to prevent collisions between a plurality of aerial drones controlled by the computing device.

8. A method for providing aerial drone assistance, the method comprising:
receiving, at a computing device in communication with an aerial drone and a mobile electronic device operated by a user, a request for assistance from the mobile electronic device;
controlling the aerial drone, using a drone summoning module, to travel to a location of the user operating the mobile electronic device; and
controlling the aerial drone, using a drone assistance module, to provide a price verification of a user-specified object or to provide navigation assistance via the aerial drone to the user to enable the user to navigate to the user-specified object.

9. The method of claim 8, wherein the mobile electronic device associated with the user includes a personal device operated by the user.

10. The method of claim 8, wherein the navigation assistance to the user-specified object is provided by the aerial drone using a visual projection or an audio output.

11. The method of claim 8, wherein the price verification of the user-specified object is provided by the aerial drone using a visual projection or an audio output.

12. The method of claim 8, further comprising:
communicating navigation assistance from the computing device to the mobile electronic device.

13. The method of claim 8, further comprising:
commanding the aerial drone, using a drone return module, to return to a specified location after the aerial drone provides a price verification of the user-specified object or provides navigation assistance that enables the user to navigate to the user-specified object.

14. The method of claim 13, further comprising:
controlling the aerial drone, using a drone control module, to prevent collisions between a plurality of aerial drones controlled by the computing device.

15. A non-transitory machine readable medium storing instructions executable by a processing device, wherein execution of the instructions causes the processing device to implement a method for providing aerial drone assistance, the method comprising:
receiving, at a computing device in communication with an aerial drone and an mobile electronic device operated by a user, a request for assistance from the mobile electronic device;
controlling the aerial drone, using a drone summoning module, to travel to a location of the user operating the mobile electronic device; and
controlling the aerial drone, using a drone assistance module, to provide a price verification of a user-specified object or to provide navigation assistance via the aerial drone to the user to enable the user to navigate to the user-specified object.

16. The non-transitory machine readable medium of claim 15, wherein the mobile electronic device associated with the user includes a personal device operated by the user.

17. The non-transitory machine readable medium of claim 15, wherein the navigation assistance to the user-specified object is provided by the aerial drone using a visual projection or an audio output.

18. The non-transitory machine readable medium of claim 15, wherein the price verification of the user-specified object is provided by the aerial drone using a visual projection or an audio output.

19. The non-transitory machine readable medium of claim 15, wherein execution of the instructions further causes the computing device to communicate navigation assistance to the mobile electronic device.

20. The non-transitory machine readable medium of claim 15, wherein execution of the instructions further causes the processing device to control the aerial drone, using a drone return module, to return to a specified location after the aerial drone provides a price verification of the user-specified object or provides navigation assistance that enables the user to navigate to the user-specified object.

21. The non-transitory machine readable medium of claim 15, wherein execution of the instructions further causes the processing device to control the aerial drone, using a drone control module, to prevent collisions between a plurality of aerial drones controlled by the computing device.
